(19) United States
(12) Patent Application Publication
(10) Pub. No.: US 2025/0371888 A1
(43) Pub. Date: Dec. 4, 2025

(54) METHOD OF ACQUIRING HIGH-DEFINITION IMAGE AND ELECTRONIC DEVICE FOR PERFORMING THE SAME

(71) Applicants: NC& Co., Ltd., Gyeonggi-do (KR); HANDONG GLOBAL UNIVERSITY INDUSTRY-ACADEMIC COOPERATION FOUNDATION, Gyeongsangbuk-do (KR)

(72) Inventors: In Jung KIM, Gyeongsangbuk-do (KR); Jun Seok OH, Daejeon (KR); Byeong Chan JEON, Gyeongsangbuk-do (KR); Jun Yeong CHOI, Gyeongsangbuk-do (KR); Gyu Hwan PARK, Gyeongsangbuk-do (KR)

(73) Assignees: NC& Co., Ltd., Gyeonggi-do (KR); HANDONG GLOBAL UNIVERSITY INDUSTRY-ACADEMIC COOPERATION FOUNDATION, Gyeongsangbuk-do (KR)

(21) Appl. No.: 18/900,878

(22) Filed: Sep. 29, 2024

(30) Foreign Application Priority Data
Jun. 3, 2024 (KR) 10-2024-0072350

(51) Int. Cl. G06V 20/62; G06T 5/40; G06T 7/20; G06V 10/24; G06V 10/60; G06V 20/56

(52) U.S. Cl. CPC G06V 20/625; G06T 5/40; G06T 7/20; G06V 10/24; G06V 10/60; G06V 20/56; G06T 2207/20132

(57) ABSTRACT

A method of generating a license plate image of a vehicle performed by an electronic device includes generating a plurality of crop images including a license plate area of a target vehicle based on a plurality of basic images of a video capturing the target vehicle, determining a reference crop image among the plurality of crop images, calculating a plurality of optical flow values between the reference crop image and each of the plurality of crop images, determining a plurality of alignment images among the plurality of crop images based on the plurality of optical flow values, and generating the license plate image based on the plurality of alignment images.

### CROSS-REFERENCE TO RELATED APPLICATION(S)

This application claims the priority benefit of Korean Patent Application No. 10-2024-0072350 filed on Jun. 3, 2024, in the Korean Intellectual Property Office, the disclosure of which is incorporated herein by reference for all purposes.

### BACKGROUND

### 1. Field

One or more embodiments relate to an image generation method and an electronic device for performing the same, and more specifically, to a method of generating an image based on a license plate of a vehicle and an electronic device for performing the same.

### 2. Description of Related Art

Technology that uses license plates to recognize vehicles has become essential in various industries and multiple sectors in society, including traffic law compliance and surveillance and security and crime prevention. However, the performance of a license plate recognition model substantially decreases in the case of low-quality videos.

To solve this issue, low-resolution vehicle license plate images need to be converted into high-resolution images. However, in this case, a license plate is not readily restored due to the degradation of a black box and the continuous movement of a vehicle and a camera.

It is necessary to provide an image generation method with securing visibility and recognition performance and an electronic device for performing the same.

### SUMMARY

An aspect provides a method of generating an image based on a vehicle license plate.

Another aspect also provides an electronic device for generating an image based on a vehicle license plate.

However, technical aspects are not limited to the foregoing aspects, and there may be other technical aspects.

According to an aspect, there is provided a method of generating a license plate image of a vehicle performed by an electronic device including generating a plurality of crop images including a license plate area of a target vehicle based on a plurality of basic images of a video capturing the target vehicle, determining a reference crop image among the plurality of crop images, calculating a plurality of optical flow values between the reference crop image and each of the plurality of crop images, determining a plurality of alignment images among the plurality of crop images based on the plurality of optical flow values, and generating the license plate image based on the plurality of alignment images.

According to an embodiment, the generating of the plurality of crop images may include determining the license plate area of the target vehicle in a first basic image, generating a first basic crop image including the determined license plate area, and generating a first crop image by up-sampling the first basic crop image.

According to an embodiment, any one of the plurality of crop images may be determined as the reference crop image based on an image generation time related to each of the plurality of crop images.

According to an embodiment, the calculating of the plurality of optical flow values may include calculating a first position change between a first pixel of the reference crop image and a second pixel of a first crop image corresponding to the first pixel and calculating a first optical flow value of the first crop image based on the first position change.

According to an embodiment, the determining of the plurality of alignment images may include determining an error image among the plurality of crop images based on the plurality of optical flow values and determining the plurality of alignment images based on the error image.

According to an embodiment, the determining of the error image may include determining a first crop image and a second crop image adjacent to the first crop image among the plurality of crop images, calculating a difference between a first optical flow value of the first crop image and a second optical flow value of the second crop image, and determining whether the first crop image is the error image based on the difference.

According to an embodiment, the generating of the license plate image may include determining a first alignment image requiring correction among the plurality of alignment images, correcting the first alignment image and generating the corrected first alignment image, and generating the license plate image based on the plurality of alignment images including the corrected first alignment image.

According to an embodiment, the determining of the first alignment image requiring the correction may include determining whether the license plate area of each of the plurality of alignment images satisfies bilinear approximation and determining that the first alignment image that does not satisfy the bilinear approximation requires correction.

According to an embodiment, the generating of the corrected first alignment image may include calculating coordinate values in the first alignment image of corners of the license plate area of the first alignment image, calculating corrected coordinate values for each of the coordinate values of the corners based on bilinear approximation, and generating the corrected first alignment image by correcting the first alignment image based on the corrected coordinate values.

According to an embodiment, the generating of the license plate image may include obtaining intensity values of pixels including the license plate area of each of the plurality of alignment images, determining pixels corresponding to a preset intensity value among the obtained intensity values, and generating the license plate image based on the determined pixels.

According to an embodiment, the generating of the license plate image may include post-processing the license plate image based on an image enhancement algorithm.

According to an embodiment, the image enhancement algorithm may include a contrast-limited adaptive histogram equalization (CLAHE) algorithm.

According to an embodiment, the method may further include determining the license plate number of the target vehicle based on the generated license plate image.

According to another aspect, there is provided an electronic device including at least one processor and a memory configured to store instructions, in which the instructions, when executed individually or collectively by the at least one processor, cause the electronic device to at least generate a plurality of crop images including a license plate area of a target vehicle based on a plurality of basic images of a video capturing the target vehicle, determine a reference crop image among the plurality of crop images, calculate a plurality of optical flow values between the reference crop image and each of the plurality of crop images, determine a plurality of alignment images among the plurality of crop images based on the plurality of optical flow values, and generate a license plate image based on the plurality of alignment images.

According to an embodiment, the instructions, when executed individually or collectively by the at least one processor, may cause the electronic device to at least determine the license plate area of the target vehicle in a first basic image, generate a first basic crop image including the determined license plate area, and generate a first crop image by up-sampling the first basic crop image.

According to an embodiment, any one of the plurality of crop images may be determined as the reference crop image based on an image generation time related to each of the plurality of crop images.

According to an embodiment, the instructions, when executed individually or collectively by the at least one processor, may cause the electronic device to at least calculate a first position change between a first pixel of the reference crop image and a second pixel of a first crop image corresponding to the first pixel and calculate a first optical flow value of the first crop image based on the first position change.

According to an embodiment, the instructions, when executed individually or collectively by the at least one processor, may cause the electronic device to at least determine an error image among the plurality of crop images based on the plurality of optical flow values and determine the plurality of alignment images based on the error image.

According to an embodiment, the instructions, when executed individually or collectively by the at least one processor, may cause the electronic device to at least determine a first crop image and a second crop image adjacent to the first crop image among the plurality of crop images, calculate a difference between a first optical flow value of the first crop image and a second optical flow value of the second crop image, and determine whether the first crop image is the error image based on the difference.

According to an embodiment, the instructions, when executed individually or collectively by the at least one processor, may cause the electronic device to at least determine a first alignment image requiring correction among the plurality of alignment images, correct the first alignment image and generate the corrected first alignment image, and generate the license plate image based on the plurality of alignment images including the corrected first alignment image.

According to an embodiment, the instructions, when executed individually or collectively by the at least one processor, may cause the electronic device to at least determine whether the license plate area of each of the plurality of alignment images satisfies bilinear approximation and determine the first alignment image that does not satisfy the bilinear approximation to require correction.

According to an embodiment, the instructions, when executed individually or collectively by the at least one processor, may cause the electronic device to at least calculate coordinate values in the first alignment image of corners of the license plate area of the first alignment image, calculate corrected coordinate values for each of the coordinate values of the corners based on bilinear approximation, and correct the first alignment image based on the corrected coordinate values and generate the corrected first alignment image.

According to an embodiment, the instructions, when executed individually or collectively by the at least one processor, may cause the electronic device to at least obtain intensity values of pixels including the license plate area of each of the plurality of alignment images, determine pixels corresponding to a preset intensity value among the obtained intensity values, and generate the license plate image based on the determined pixels.

According to an embodiment, the instructions, when executed individually or collectively by the at least one processor, may cause the electronic device to at least post-process the license plate image based on an image enhancement algorithm.

According to an embodiment, the image enhancement algorithm may include a CLAHE algorithm.

According to an embodiment, the instructions, when executed individually or collectively by the at least one processor, may cause the electronic device to at least determine a license plate number of the target vehicle based on the generated license plate image.

### BRIEF DESCRIPTION OF THE DRAWINGS

FIG. 1 is a diagram illustrating an electronic device and a target vehicle, according to an embodiment.

FIG. 2 is a diagram illustrating a system of an electronic device, according to an embodiment.

FIG. 3 is a flowchart illustrating an image generation method according to an embodiment.

FIG. 4 is a flowchart illustrating an operation of generating crop images, according to an embodiment.

FIG. 5 is a diagram illustrating crop images and a reference crop image, according to an embodiment.

FIG. 6 is a flowchart illustrating an operation of calculating optical flow values, according to an embodiment.

FIGS. 7A and 7B are diagrams each illustrating an operation of calculating optical flow values, according to an embodiment.

FIG. 8 is a flowchart illustrating an operation of determining alignment images, according to an embodiment.

FIG. 9 is a flowchart illustrating an operation of determining an error image, according to an embodiment.

FIG. 10 is a flowchart illustrating an operation of generating a license plate image, according to an embodiment.

FIG. 11 is a flowchart illustrating an operation of determining a first alignment image, according to an embodiment.

FIG. 12 is a flowchart illustrating an operation of generating a corrected first alignment image, according to an embodiment.

FIG. 13 is a diagram illustrating an operation of correcting a first alignment image, according to an embodiment.

FIG. 14 is a flowchart illustrating an operation of generating a license plate image, according to an embodiment.

### DETAILED DESCRIPTION

The following detailed structural or functional description is provided as an example only and various alterations and modifications may be made to embodiments. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

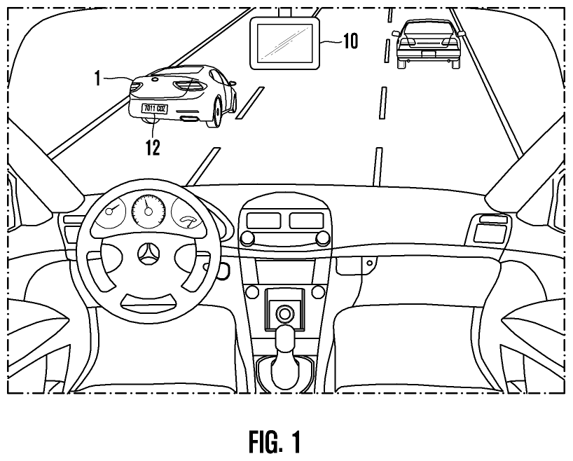

FIG. 1 is a diagram illustrating an electronic device and a target vehicle, according to an embodiment.

FIG. 1 illustrates a target vehicle 1, a license plate area 12 of the target vehicle 1, and an electronic device 10 (e.g., a black box). In an example, the electronic device 10 may include a display module, a sensor, and a camera module. In an example, the sensor may be an inertial sensor for measuring a change in acceleration and a speed sensor for determining the speed of a vehicle. The camera module may capture the surroundings of the vehicle. The electronic device 10 may generate one or more frames for the surroundings (e.g., the target vehicle 1) of the vehicle based on the camera module. The electronic device 10 may generate a video of the surroundings of the vehicle based on the one or more frames.

In an embodiment, the electronic device 10 may generate a video capturing the target vehicle 1. The electronic device 10 may generate a plurality of crop images including the license plate area 12 of the target vehicle 1 based on a plurality of basic images (e.g., the frames) of the video capturing the target vehicle 1. The crop image may be a part of a basic image including the license plate image 12 of the target vehicle 1. In an embodiment, the electronic device 10 may determine a reference crop image among the generated plurality of crop images. The reference crop image may be an image referred to by the crop images. In an embodiment, the electronic device 10 may calculate a plurality of optical flow values between the determined reference crop image and the plurality of crop images. In an embodiment, the electronic device 10 may determine a plurality of alignment images among the plurality of crop images based on the calculated plurality of optical flow values. An alignment image may be an image used directly to generate a license plate image among the crop images. In an embodiment, the electronic device 10 may generate the license plate image based on the plurality of alignment images. The license plate image may include the license plate area 12 of the target vehicle 1 and may be an image with a higher resolution than that of a crop image.

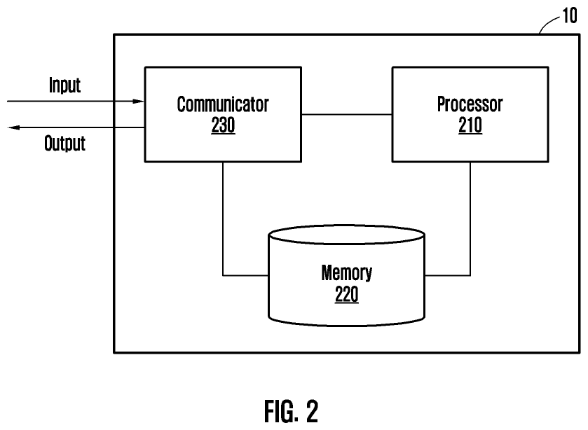

The image generation method and an electronic device for performing the same are described in detail below with reference to FIGS. 2 to 14.

FIG. 2 is a diagram illustrating a system of an electronic device, according to an embodiment.

According to an embodiment, an electronic device 10 (e.g., the electronic device 10 of FIG. 1) may include at least one processor 210, a memory 220 that stores instructions, and a communicator 230.

The electronic device 10 may generate one or more frames for the surroundings (e.g., the target vehicle 1 of FIG. 1) of a vehicle. The electronic device 10 may generate a video of the surroundings of the vehicle based on the one or more frames.

When the instructions are executed, the processor 210 may cause the electronic device 10 to generate a plurality of crop images including a license plate area of a target vehicle based on a plurality of basic images of a video capturing the target vehicle, to determine a reference crop image among the plurality of crop images, to calculate a plurality of optical flow values between the reference crop image and each of the plurality of crop images, to determine a plurality of alignment images among the plurality of crop images based on the plurality of optical flow values, and to generate a license plate image based on the plurality of alignment images.

The processor 210 may process data received by the communicator 230 and stored in the memory 220. A “processor” described herein may be a hardware-implemented data processing device having a physically structured circuit to execute desired operations. The desired operations may include, for example, codes or instructions included in a program. For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The processor 210 may execute computer-readable code (e.g., software) stored in a memory (e.g., the memory 220) and instructions triggered by the processor 210.

The memory 220 may store data received by the communicator 230 and data processed by the processor 210. For example, the memory 220 may store a program (or an application or software). The program to be stored may be a set of syntaxes that are coded and executable by the processor 210 to control the electronic device 10 (e.g., a black box).

In an example, the memory 220 may include, for example, at least one volatile memory, non-volatile memory, random-access memory (RAM), flash memory, a hard disk drive, and an optical disc drive.

The memory 220 may store an instruction set (e.g., software) for operating the electronic device 10. The instruction set for operating the electronic device 10 may be executed by the processor 210.

The communicator 230 may be connected to the processor 210 and the memory 220 and may transmit and receive data to and from the processor 210 and the memory 220. The communicator 230 may be connected to another external device and may transmit and receive data to and from the external device. Hereinafter, transmitting and receiving “A” may refer to transmitting and receiving “information or data indicating A”.

The communicator 230 may be implemented as circuitry in the electronic device 10. For example, the communicator 230 may include an internal bus and an external bus. In another example, the communicator 230 may be an element that connects the electronic device 10 to an external device. The communicator 230 may be an interface. The communicator 230 may receive data from the external device and transmit the data to the processor 210 and the memory 220.

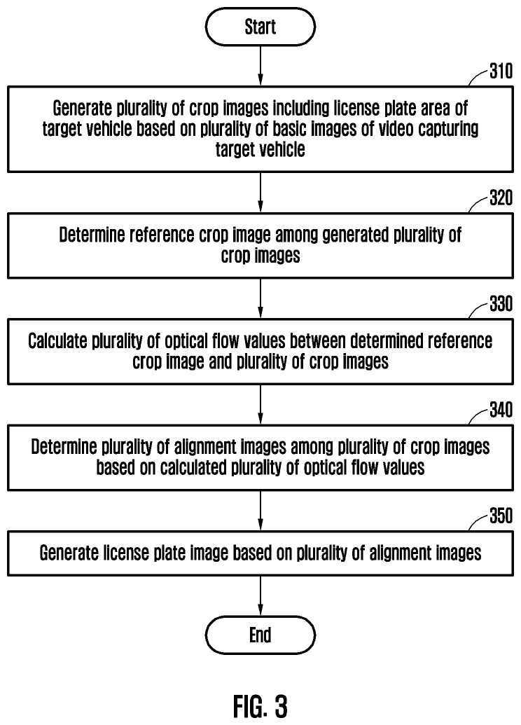

FIG. 3 is a flowchart illustrating an image generation method according to an embodiment.

An electronic device (e.g., the electronic device 10 of FIG. 1 or 2) may perform operations 310 to 350. For example, the electronic device may include a processor (e.g., the processor 210 of FIG. 2), a memory (e.g., the memory 220 of FIG. 2), and a communicator (e.g., the communicator 230 of FIG. 2).

Before operation 310, the electronic device may generate one or more frames for the surroundings (e.g., the target vehicle 1 of FIG. 1) of the vehicle. The electronic device may generate a video of the surroundings of the vehicle based on the one or more frames.

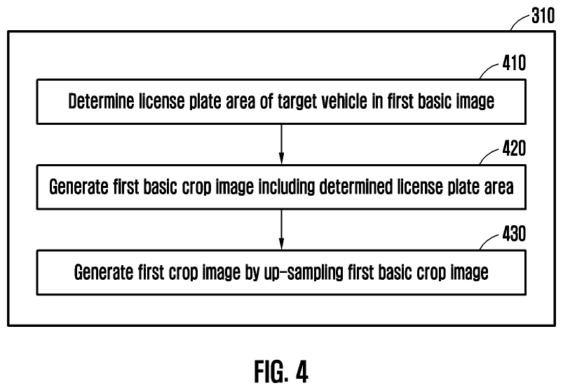

In operation 310, the electronic device may generate a plurality of crop images including the license plate area (e.g., the license plate area 12 of FIG. 1) of the target vehicle based on a plurality of basic images (e.g., the frames) of the video capturing the target vehicle. A crop image may be a part of a basic image including the license plate image of the target vehicle. The size or resolution of the crop image may vary depending on the distance between the electronic device and the target vehicle. For example, when the distance between the electronic device and the target vehicle is close, the size or resolution of the crop image may be greater than that of the crop image when the distance between the electronic device and the target vehicle is far. The method of generating the plurality of crop images is described in detail below with reference to FIG. 4.

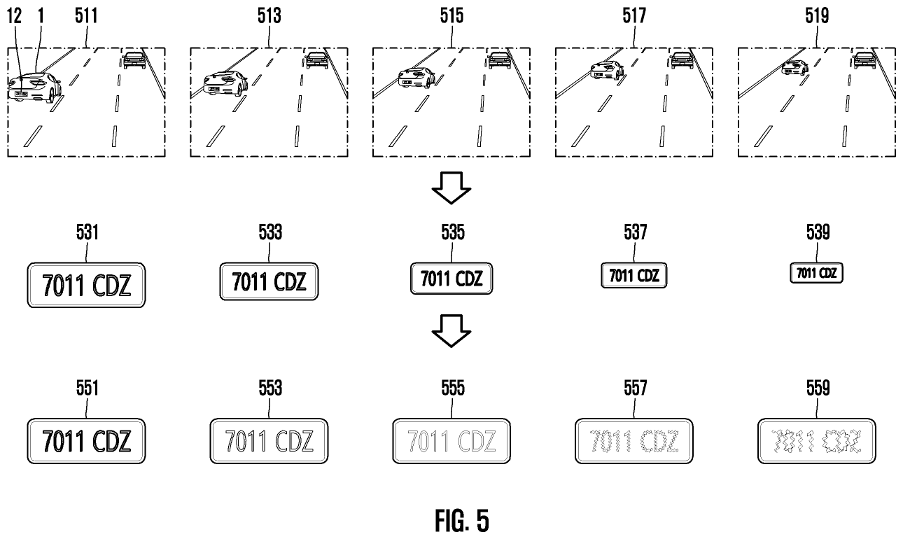

In operation 320, the electronic device may determine a reference crop image among the generated plurality of crop images. The reference crop image may be an image referred to by the crop images. For example, any one of the plurality of crop images may be determined as the reference crop image based on an image generation time related to each of the plurality of crop images. The reference crop image is described in detail below with reference to FIG. 5.

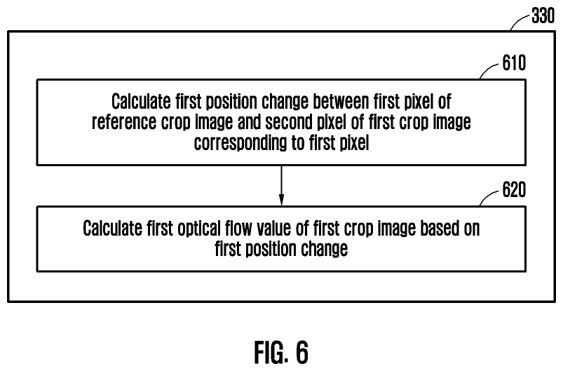

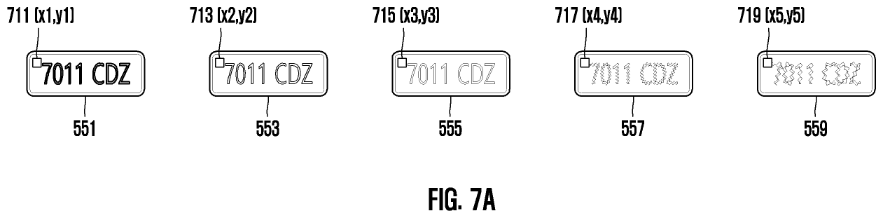

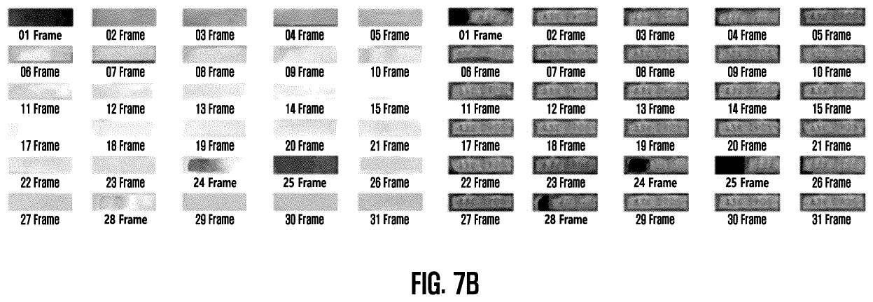

In operation 330, the electronic device may calculate a plurality of optical flow values between the determined reference crop image and the plurality of crop images. The method of calculating the plurality of optical flow values is described in detail below with reference to FIGS. 6 to 7B.

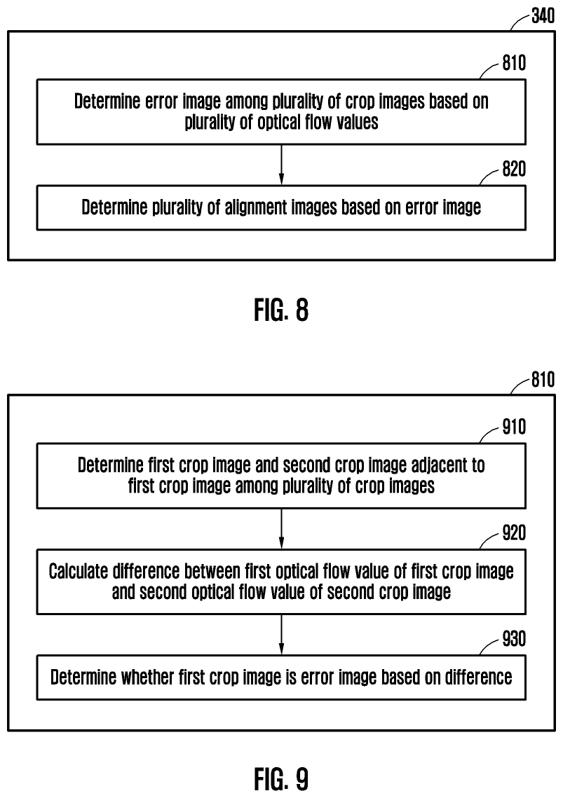

In operation 340, the electronic device may determine a plurality of alignment images among the plurality of crop images based on the calculated plurality of optical flow values. For example, an alignment image may be an image used directly to generate a license plate image among the crop images. The method of determining the plurality of alignment images is described in detail below with reference to FIGS. 8 and 9.

In operation 350, the electronic device may generate the license plate image based on the plurality of alignment images. The license plate image may include the license plate area of the target vehicle and may be an image with a higher resolution than that of a crop image. The method of generating the license plate image is described in detail below with reference to FIGS. 10 to 14.

In an embodiment, the electronic device may further perform the determining of the license plate number of the target vehicle based on the generated license plate image. For example, based on an optical character recognition (OCR) method, the electronic device may recognize or extract the license plate number of the target vehicle from the generated license plate image as text. The method of the electronic device determining the license plate number of the target vehicle is not limited to the embodiments described herein.

FIG. 4 is a flowchart illustrating an operation of generating crop images, according to an embodiment.

An electronic device (e.g., the electronic device 10 of FIG. 1 or 2) may perform operations 410 to 430. For example, the electronic device may include a processor (e.g., the processor 210 of FIG. 2), a memory (e.g., the memory 220 of FIG. 2), and a communicator (e.g., the communicator 230 of FIG. 2).

According to an embodiment, operation 310 described above with reference to FIG. 3 may include operations 410 to 430.

In operation 410, the electronic device may determine the license plate area of the target vehicle in a first basic image. For example, the first basic image may be a full-size image generated by the electronic device. The first basic image may include an image of a target vehicle (e.g., the target vehicle 1 of FIG. 1). For example, the electronic device may determine the license plate area of the target vehicle based on a convolutional neural network (CNN) method. The method of the electronic device determining the license plate area of the target vehicle is not limited to the embodiments described herein.

In operation 420, the electronic device may generate a first basic crop image including the determined license plate area. For example, the first basic crop image may be an image that crops the remaining area excluding the license plate area of the target vehicle from the first basic image. The size or resolution of the first basic crop image may vary depending on the distance between the electronic device and the target vehicle.

In operation 430, the electronic device may generate a first crop image by up-sampling the first basic crop image. When the distance between the electronic device and the target vehicle is far, the size or resolution of the first basic crop image may be less than that of the first basic crop image when the distance between the electronic device and the target vehicle is close. Based on the up-sampling method, crop images with a constant size may be generated from basic crop images with different sizes. In an example, the size of a plurality of crop images may be the same.

FIG. 5 is a diagram illustrating crop images and a reference crop image, according to an embodiment.

FIG. 5 illustrates a plurality of basic images 511, 513, 515, 517, and 519, a plurality of basic crop images 531, 533, 535, 537, and 539, and a plurality of crop images 551, 553, 555, 557, and 559, according to an embodiment.

According to an embodiment, an electronic device (e.g., the electronic device 10 of FIG. 1 or 2) may generate one or more frames including the target vehicle 1 before operation 310 described above with reference to FIG. 3. The electronic device may generate a video of the target vehicle 1 based on the one or more frames. The video of the target vehicle 1 may include the plurality of basic images 511, 513, 515, 517, and 519. In an example, in the plurality of basic images 511, 513, 515, 517, and 519, the size of an image of the target vehicle 1 may vary based on the distance between the electronic device and the target vehicle 1. For example, in the plurality of basic images 511, 513, 515, 517, and 519, the size of the image of the target vehicle 1 may gradually decrease as the distance between the electronic device and the target vehicle 1 increases.

According to an embodiment, in operation 310 described above with reference to FIG. 3, the electronic device may generate the plurality of crop images 551, 553, 555, 557, and 559 including the license plate area 12 of the target vehicle 1, based on the plurality of basic images 511, 513, 515, 517, and 519 of the video capturing the target vehicle 1.

Referring to FIG. 4 again, in operation 410 described above, the electronic device may determine the license plate area 12 of the target vehicle 1 in the plurality of basic images 511, 513, 515, 517, and 519.

In operation 420 described above with reference to FIG. 4, the electronic device may generate the plurality of basic crop images 531, 533, 535, 537, and 539 including the determined license plate area 12. In an example, the size of the plurality of basic crop images 531, 533, 535, 537, and 539 may vary based on the distance between the electronic device and the target vehicle 1. For example, the size of the plurality of basic crop images 531, 533, 535, 537, and 539 may gradually decrease as the distance between the electronic device and the target vehicle 1 increases.

In operation 430 described above with reference to FIG. 4, the electronic device may generate the plurality of crop images 551, 553, 555, 557, and 559 by up-sampling the plurality of basic crop images 531, 533, 535, 537, and 539. The size of the plurality of crop images 551, 553, 555, 557, and 559 may be the same. In the process of up-sampling basic crop images to crop images, the resolutions of the plurality of crop images 551, 553, 555, 557, and 559 may vary.

According to an embodiment, in operation 320 described above with reference to FIG. 3, the electronic device may determine a reference crop image among the plurality of crop images 551, 553, 555, 557, and 559. The reference crop image may be an image referred to by the crop images 551, 553, 555, 557, and 559. For example, any one of the plurality of crop images 551, 553, 555, 557, and 559 may be determined as the reference crop image based on an image generation time related to each of the plurality of crop images 551, 553, 555, 557, and 559.

For example, the crop image 551 generated at the earliest time among the plurality of crop images 551, 553, 555, 557, and 559 may be determined as the reference crop image based on the image generation time. For example, the crop image 559 generated at the latest time among the plurality of crop images 551, 553, 555, 557, and 559 may be determined as the reference crop image based on the image generation time. For example, the crop image 555 generated at a time of a median value among the plurality of crop images 551, 553, 555, 557, and 559 may be determined as the reference crop image based on the image generation time. The criteria and method of determining the reference crop image are not limited to the embodiments described herein.

Hereinafter, for ease of description, the crop image 555 generated at the time of the median value among the plurality of crop images 551, 553, 555, 557, and 559 is described as the reference crop image based on the image generation time.

FIG. 6 is a flowchart illustrating an operation of calculating optical flow values, according to an embodiment.

An electronic device (e.g., the electronic device 10 of FIG. 1 or 2) may perform operations 610 and 620. For example, the electronic device may include a processor (e.g., the processor 210 of FIG. 2), a memory (e.g., the memory 220 of FIG. 2), and a communicator (e.g., the communicator 230 of FIG. 2).

According to an embodiment, operation 330 described above with reference to FIG. 3 may include operations 610 and 620.

In operation 610, the electronic device may calculate a first position change between a first pixel of a reference crop image and a second pixel of a first crop image corresponding to the first pixel. In a plurality of crop images, the position or angle of a license plate area of a target vehicle may change over time. Based on optical flows, the movement patterns among the plurality of crop images may be identified. For example, a direction or distance, in which a specific pixel between the first crop image and a second crop image moves, may be calculated based on the optical flows. In an example, based on the optical flows, a position change of a respective pixel corresponding to the license plate area of the target vehicle included in the plurality of crop images may be estimated. In an example, the reference crop image (e.g., the reference crop image 555 of FIG. 5) may be used as reference coordinates for estimating the position change of a corresponding pixel. The electronic device may calculate a first position change between a first pixel (e.g., an upper left corner of the license plate area of the reference crop image) of the reference crop image 555 and a second pixel (e.g., an upper left corner of the license plate area of a first crop image) of the first crop image (e.g., the crop image 551 of FIG. 5) corresponding to the first pixel.

In operation 620, the electronic device may calculate a first optical flow value of the first crop image based on the first position change. In an example, the first optical flow value of the first crop image may be calculated based on the first position change between the first pixel of the reference crop image and the second pixel of the first crop image corresponding to the first pixel.

FIGS. 7A and 7B are diagrams each illustrating an operation of calculating optical flow values, according to an embodiment.

FIG. 7A illustrates the reference crop image 555 and the plurality of crop images 551, 553, 555, 557, and 559, according to an embodiment.

According to an embodiment, in operation 610 described above with reference to FIG. 6, the electronic device may calculate a first position change (e.g., a position change between (x3, y3) and (x1, y1)) between a first pixel 715 of the reference crop image 555 and a second pixel 711 of the first crop image 551 corresponding to the first pixel 715. In this method, the electronic device may calculate each of the position changes between the first pixel 715 of the reference crop image 555 and a respective pixel of a plurality of crop images corresponding to the first pixel 715.

According to an embodiment, in operation 620 described above with reference to FIG. 6, the electronic device may calculate a first optical flow value of the first crop image 551 based on the first position change. In this method, the electronic device may calculate a plurality of optical flow values respectively of the plurality of crop images.

FIG. 7B illustrates thirty crop images according to an embodiment. Optical flow values respectively of the thirty crop images may be calculated based on operations 610 and 620 described above with reference to FIG. 6. Based on thirty optical flow values, crop images respectively corresponding to 01 Frame, 24 Frame, 25 Frame, and 28 Frame may be determined as error images.

An error image is described in detail below with reference to FIGS. 8 and 9.

FIG. 8 is a flowchart illustrating an operation of determining alignment images, according to an embodiment.

An electronic device (e.g., the electronic device 10 of FIG. 1 or 2) may perform operations 810 and 820. For example, the electronic device may include a processor (e.g., the processor 210 of FIG. 2), a memory (e.g., the memory 220 of FIG. 2), and a communicator (e.g., the communicator 230 of FIG. 2).

According to an embodiment, operation 340 described above with reference to FIG. 3 may include operations 810 and 820.

In operation 810, the electronic device may determine an error image among a plurality of crop images based on a plurality of optical flow values. The movement of the electronic device and a target vehicle (e.g., the target vehicle 1 of FIG. 1) is continuous. Thus, a change in an optical flow value between the plurality of crop images should not be large. For example, if the change in an optical flow value is large, a corresponding crop image may be estimated as an error image.

The operation of determining an error image is described in detail below with reference to FIG. 9.

In operation 820, the electronic device may determine a plurality of alignment images based on an error image. The crop image determined as an error image may be hardly or not readily corrected. In an example, the electronic device may determine the remaining crop images excluding the error image as alignment images among the plurality of crop images. FIG. 9 is a flowchart illustrating an operation of determining an error image, according to an embodiment.

An electronic device (e.g., the electronic device 10 of FIG. 1 or 2) may perform operations 910 to 930. For example, the electronic device may include a processor (e.g., the processor 210 of FIG. 2), a memory (e.g., the memory 220 of FIG. 2), and a communicator (e.g., the communicator 230 of FIG. 2).

According to an embodiment, operation 810 described above with reference to FIG. 8 may include operations 910 to 930.

In operation 910, the electronic device may determine a first crop image and a second crop image adjacent to the first crop image among the plurality of crop images. For example, referring to FIG. 7A, the electronic device may determine the crop image 551 and the second crop image 553 adjacent to the first crop image 551 among the plurality of crop images 551, 553, 555, 557, and 559.

In operation 920, the electronic device may calculate a difference between a first optical flow value of the first crop image and a second optical flow value of the second crop image. For example, referring to FIG. 7A, the first optical flow value of the first crop image 551 may be calculated based on the first position change (e.g., the position change between (x3, y3) and (x1, y1)) between the first pixel 715 of the reference crop image 555 and the second pixel 711 of the first crop image 551 corresponding to the first pixel 715. For example, referring to FIG. 7A, the second optical flow value of the second crop image 553 may be calculated based on a second position change (e.g., a position change between (x3, y3) and (x2, y2)) between the first pixel 715 of the reference crop image 555 and a third pixel 713 of the second crop image 553 corresponding to the first pixel 715. In an example, the electronic device may calculate a difference between the first optical flow value of the first crop image 551 and the second optical flow value of the second crop image 553 based on the first position change and the second position change.

In operation 930, the electronic device may determine whether the first crop image is an error image based on the difference. In an example, the electronic device may determine an error image based on a difference between adjacent crop images. For example, the electronic device may calculate an absolute value of a difference between optical flow values (e.g., the first optical flow value and the second optical flow value) between the adjacent crop images (e.g., the first crop image and the second crop image). The electronic device may calculate an average of absolute values of a plurality of optical flow values between a plurality of adjacent crop images. In an example, the electronic device may compare the average of absolute values with a preset threshold value as shown in [Equation 1] below.

$$Mean ( \vert {f}_{t} - {f}_{t + 1} \vert ) > {θ}_{temp} and Mean ( \vert {f}_{t} - {f}_{t + 1} \vert ) > {θ}_{temp} \qquad [ Equation 1 ]$$

In [Equation 1], ft denotes an optical flow value of an adjacent crop image at a t distance from a reference crop image. For example, θₜₑₘₚ denotes a preset threshold value. An absolute value of a difference between optical flow values between crop images adjacent to the front/back may be compared with the preset threshold value. For example, if all the comparison results are greater than the preset threshold value, a corresponding crop image may be determined as an error image. The calculation method for determining whether a crop image is an error image is not limited to the embodiments described herein.

FIG. 10 is a flowchart illustrating an operation of generating a license plate image, according to an embodiment.

An electronic device (e.g., the electronic device 10 of FIG. 1 or 2) may perform operations 1010 to 1030. For example, the electronic device may include a processor (e.g., the processor 210 of FIG. 2), a memory (e.g., the memory 220 of FIG. 2), and a communicator (e.g., the communicator 230 of FIG. 2).

According to an embodiment, operation 350 described above with reference to FIG. 3 may include operations 1010 to 1030.

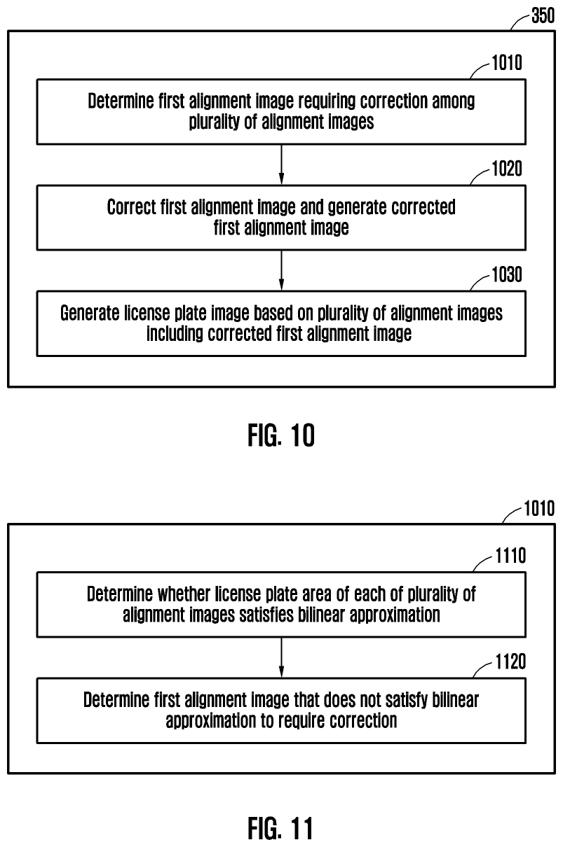

In operation 1010, the electronic device may determine a first alignment image requiring correction among a plurality of alignment images. A license plate area (e.g., the license plate area 12 of FIG. 1) of a target vehicle (e.g., the target vehicle 1 of FIG. 1) forms a plane, which is attached to and moves together with the target vehicle. For example, based on optical flow results, a non-planar portion of the license plate area may be determined to require correction. In an example, the electronic device may determine the first alignment image corresponding to a non-planar portion among the plurality of alignment images. The operation of determining the first alignment image requiring correction is described in detail below with reference to FIG. 11.

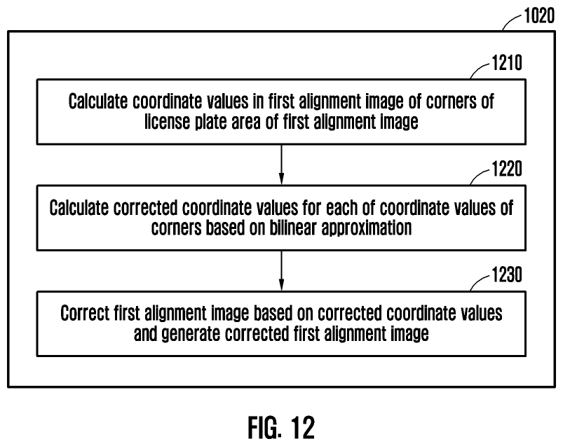

In operation 1020, the electronic device may correct the first alignment image and generate the corrected first alignment image. The operation of generating the corrected first alignment image is described in detail below with reference to FIG. 12.

In operation 1030, the electronic device may generate the license plate image based on the plurality of alignment images including the corrected first alignment image. In an embodiment, the electronic device may generate the license plate image based on a plurality of alignment images not requiring correction and corrected alignment images.

FIG. 11 is a flowchart illustrating an operation of determining a first alignment image, according to an embodiment.

An electronic device (e.g., the electronic device 10 of FIG. 1 or 2) may perform operations 1110 and 1120. For example, the electronic device may include a processor (e.g., the processor 210 of FIG. 2), a memory (e.g., the memory 220 of FIG. 2), and a communicator (e.g., the communicator 230 of FIG. 2).

According to an embodiment, operation 1010 described above with reference to FIG. 10 may include operations 1110 and 1120.

In operation 1110, the electronic device may determine whether the license plate area of each of a plurality of alignment images satisfies bilinear approximation. In an embodiment, the electronic device may obtain coordinate values respectively corresponding to four corners (e.g., an upper left corner, an upper right corner, a lower left corner, and a lower right corner) for a license plate area of each of the plurality of alignment images. The electronic device may determine whether four corners of the license plate area of each of the plurality of alignment images satisfies bilinear approximation.

In operation 1120, the electronic device may determine the first alignment image that does not satisfy the bilinear approximation to require correction. In an example, among the alignment images, the electronic device may determine an image having four corners of the license plate area that do not satisfy bilinear approximation to require correction.

FIG. 12 is a flowchart illustrating an operation of generating a corrected first alignment image, according to an embodiment.

An electronic device (e.g., the electronic device 10 of FIG. 1 or 2) may perform operations 1210 to 1230. For example, the electronic device may include a processor (e.g., the processor 210 of FIG. 2), a memory (e.g., the memory 220 of FIG. 2), and a communicator (e.g., the communicator 230 of FIG. 2).

According to an embodiment, operation 1020 described above with reference to FIG. 10 may include operations 1210 to 1230.

In operation 1210, the electronic device may calculate coordinate values in a first alignment image of corners of the license plate area of the first alignment image. In an embodiment, the electronic device may calculate coordinate values in the first alignment image respectively for four corners (e.g., an upper left corner, an upper right corner, a lower left corner, and a lower right corner) of the license plate area of the first alignment image having been determined to require correction.

In operation 1220, the electronic device may calculate corrected coordinate values for each of the coordinate values of the corners based on bilinear approximation. For example, the electronic device may calculate the corrected coordinate values satisfying bilinear approximation based on an equation of a vertical/horizontal straight line passing the center of the license plate area of the first alignment image. For example, the electronic device may calculate the equation of a vertical/horizontal straight line passing the center of the license plate area of the first alignment image based on a vertical/horizontal median vector. In an example, the electronic device may calculate a straight-line equation excluding values (e.g., values corresponding to upper/lower 15% or values corresponding to upper/lower 7.5%) outside a preset range to reduce an error range. The method for reducing an error range and the preset range are not limited to the embodiments described herein.

In operation 1230, the electronic device may correct the first alignment image based on the corrected coordinate values and generate the corrected first alignment image. The electronic device may correct the first alignment image having been determined to require correction, based on the corrected coordinate values satisfying bilinear approximation. The electronic device may correct the first alignment image and generate the corrected first alignment image.

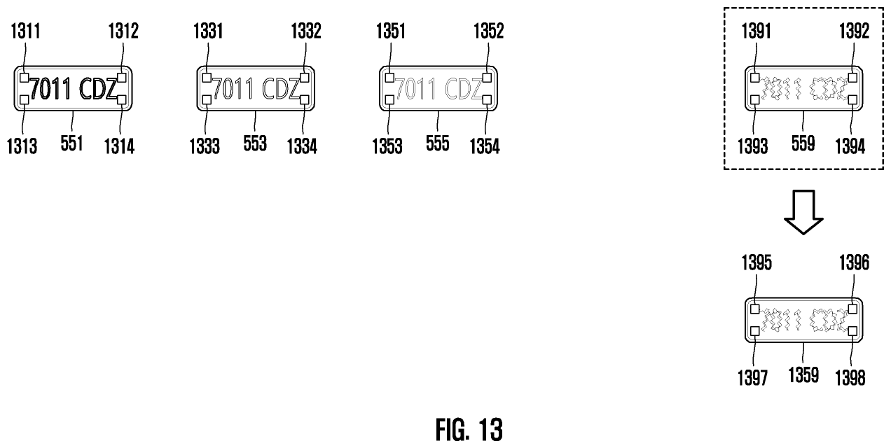

FIG. 13 is a diagram illustrating an operation of correcting a first alignment image, according to an embodiment.

FIG. 13 illustrates a plurality of alignment images 551, 553, 555, and 559 according to an embodiment.

According to an embodiment, in operation 810 described above with reference to FIG. 8, the electronic device may determine an error image (e.g., the error image 557 of FIG. 7A) among a plurality of crop images (e.g., the plurality of crop images 551, 553, 555, 557, and 559 of FIG. 7A). According to an embodiment, in operation 820 described above with reference to FIG. 8, the electronic device may determine the plurality of alignment images 551, 553, 555, and 559 based on the error image.

According to an embodiment, in operation 1010 described above with reference to FIG. 10, the electronic device may determine the first alignment image 559 requiring correction among the plurality of alignment images 551, 553, 555, and 559.

Referring to FIG. 11 again, in operation 1110, the electronic device may determine whether a license plate area of each of the plurality of alignment images 551, 553, 555, and 559 satisfies bilinear approximation. The electronic device may obtain coordinate values respectively corresponding to four corners for the license plate area of each of the plurality of alignment images 551, 553, 555, and 559. For example, coordinate values 1311, 1312, 1313, and 1314 respectively corresponding to four corners may be obtained for the license plate area of the image 551. The electronic device may determine whether the four corners of each license plate area satisfy bilinear approximation.

In operation 1120 described above with reference to FIG. 11, the electronic device may determine the first alignment image that does not satisfy the bilinear approximation to require correction. For example, the electronic device may determine the first alignment image 559 that does not satisfy the bilinear approximation to require correction.

According to an embodiment, in operation 1020 described above with reference to FIG. 10, the electronic device may generate a corrected first alignment image 1359 by correcting the first alignment image 559 requiring correction.

In operation 1210 described above with reference to FIG. 12, the electronic device may calculate coordinate values in the first alignment image 559 of corners 1391, 1392, 1393, and 1394 of the license plate area of the first alignment image 559.

In operation 1220 described above with reference to FIG. 12, the electronic device may calculate corrected coordinate values 1395, 1396, 1397, and 1398 for each of the coordinate values of the corners 1391, 1392, 1393, and 1394 based on bilinear approximation.

In operation 1230 described above with reference to FIG. 12, the electronic device may generate the corrected first alignment image 1359 by correcting the first alignment image 559 based on the corrected coordinate values 1395, 1396, 1397, and 1398.

According to an embodiment, in operation 1030 described above with reference to FIG. 10, the electronic device may generate a license plate image based on the plurality of alignment images 551, 553, 555, and 1359 including the corrected first alignment image 1359.

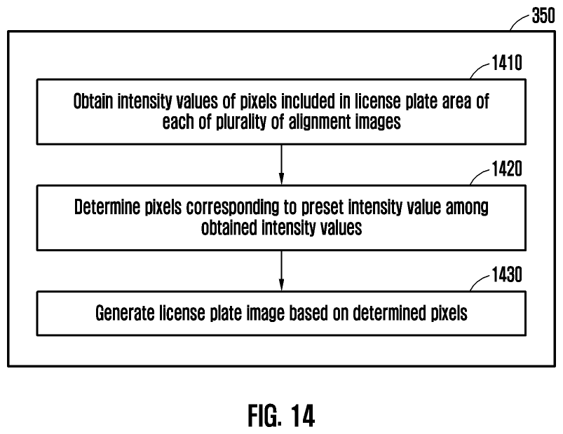

FIG. 14 is a flowchart illustrating an operation of generating a license plate image, according to an embodiment.

An electronic device (e.g., the electronic device 10 of FIG. 1 or 2) may perform operations 1410 to 1430. For example, the electronic device may include a processor (e.g., the processor 210 of FIG. 2), a memory (e.g., the memory 220 of FIG. 2), and a communicator (e.g., the communicator 230 of FIG. 2).

According to an embodiment, operation 350 described above with reference to FIG. 3 may include operations 1410 to 1430.

For example, a license plate area may be divided into a background area and an information area (e.g., a license plate number, like numbers or letters). In the license plate area, the information area may be more important than the background area. According to an embodiment, the electronic device may increase the visibility of the license plate image by processing the proportion of the background area and the information area differently.

In operation 1410, the electronic device may obtain intensity values of pixels included in the license plate area of each of a plurality of alignment images. For example, colors in an image may be defined pixel by pixel. Each pixel may have a specific intensity value (or a color value). The intensity values of pixels may refer to how bright or dark those pixels are or which colors those pixels represent. For example, the intensity of a bright color may be high, and the intensity of a dark color may be low. In an embodiment, the electronic device may obtain intensity values respectively for all the pixels included in the license plate area of each of a plurality of alignment images.

In operation 1420, the electronic device may determine pixels corresponding to a preset intensity value among the obtained intensity values. For example, when the background area is a bright color, and the information area is a dark color, the electronic device may determine pixels with a low-intensity value to be the information area of a license plate based on the preset intensity value. For example, when the background area is a dark color, and the information area is a bright color, the electronic device may determine pixels with a high-intensity value to be the information area of a license plate based on the preset intensity value. The preset intensity value may vary depending on the color composition of a license plate and is not limited to the embodiments described herein.

In operation 1430, the electronic device may generate the license plate image based on the determined pixels. In an example, the electronic device may determine pixels corresponding to the information area based on the preset intensity value. The electronic device may generate the license plate image by applying a weight to the pixels corresponding to the information area.

According to an embodiment, operation 350 described above with reference to FIG. 3 may further include an operation of post-processing the license plate image based on an image enhancement algorithm. In an example, the image enhancement algorithm may include a contrast-limited adaptive histogram equalization (CLAHE) algorithm. Based on the image enhancement algorithm, the visibility of the license plate image may increase. According to an embodiment, the operation of post-processing the license plate image based on the image enhancement algorithm may be performed in parallel with or independently of operations 1410 to 1430.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method of generating a license plate image of a vehicle performed by an electronic device, the method comprising:
generating a plurality of crop images comprising a license plate area of a target vehicle based on a plurality of basic images of a video capturing the target vehicle;
determining a reference crop image among the plurality of crop images;
calculating a plurality of optical flow values between the reference crop image and each of the plurality of crop images;
determining a plurality of alignment images among the plurality of crop images based on the plurality of optical flow values; and
generating the license plate image based on the plurality of alignment images.

2. The method of claim 1, wherein the generating the plurality of crop images comprises:
determining the license plate area of the target vehicle in a first basic image;
generating a first basic crop image comprising the determined license plate area; and
generating a first crop image by up-sampling the first basic crop image.

3. The method of claim 1, wherein any one of the plurality of crop images is determined as the reference crop image based on an image generation time related to each of the plurality of crop images.

4. The method of claim 1, wherein the calculating the plurality of optical flow values comprises:
calculating a first position change between a first pixel of the reference crop image and a second pixel of a first crop image corresponding to the first pixel; and
calculating a first optical flow value of the first crop image based on the first position change.

5. The method of claim 1, wherein the determining the plurality of alignment images comprises:
determining an error image among the plurality of crop images based on the plurality of optical flow values; and
determining the plurality of alignment images based on the error image.

6. The method of claim 5, wherein the determining the error image comprises:
determining a first crop image and a second crop image adjacent to the first crop image among the plurality of crop images;
calculating a difference between a first optical flow value of the first crop image and a second optical flow value of the second crop image; and
determining whether the first crop image is the error image based on the difference.

7. The method of claim 1, wherein the generating the license plate image comprises:
determining a first alignment image requiring correction among the plurality of alignment images;
correcting the first alignment image and generating the corrected first alignment image; and
generating the license plate image based on the plurality of alignment images comprising the corrected first alignment image.

8. The method of claim 7, wherein the determining the first alignment image requiring the correction comprises:
determining whether the license plate area of each of the plurality of alignment images satisfies bilinear approximation; and
determining that the first alignment image that does not satisfy the bilinear approximation requires correction.

9. The method of claim 7, wherein the generating the corrected first alignment image comprises:
calculating coordinate values in the first alignment image of corners of the license plate area of the first alignment image;
calculating corrected coordinate values for each of the coordinate values of the corners based on bilinear approximation; and
generating the corrected first alignment image by correcting the first alignment image based on the corrected coordinate values.

10. The method of claim 1, wherein the generating the license plate image comprises:
obtaining intensity values of pixels comprising the license plate area of each of the plurality of alignment images;
determining pixels corresponding to a preset intensity value among the obtained intensity values; and
generating the license plate image based on the determined pixels.

11. The method of claim 1, wherein the generating the license plate image comprises post-processing the license plate image based on an image enhancement algorithm.

12. The method of claim 11, wherein the image enhancement algorithm comprises a contrast-limited adaptive histogram equalization (CLAHE) algorithm.

13. The method of claim 1, further comprising determining a license plate number of the target vehicle based on the generated license plate image.

14. A non-transitory computer-readable storage medium storing instructions that, when executed by a processor, cause the processor to perform the method of claim 1.

15. An electronic device comprising:
at least one processor; and
a memory configured to store instructions,
wherein the instructions, when executed individually or collectively by the at least one processor, cause the electronic device to at least
generate a plurality of crop images comprising a license plate area of a target vehicle based on a plurality of basic images of a video capturing the target vehicle,
determine a reference crop image among the plurality of crop images,
calculate a plurality of optical flow values between the reference crop image and each of the plurality of crop images,
determine a plurality of alignment images among the plurality of crop images based on the plurality of optical flow values, and
generate a license plate image based on the plurality of alignment images.

16. The electronic device of claim 15, wherein the instructions, when executed individually or collectively by the at least one processor, cause the electronic device to at least
determine the license plate area of the target vehicle in a first basic image,
generate a first basic crop image comprising the determined license plate area, and
generate a first crop image by up-sampling the first basic crop image.

17. The electronic device of claim 15, wherein any one of the plurality of crop images is determined as the reference crop image based on an image generation time related to each of the plurality of crop images.

18. The electronic device of claim 15, wherein the instructions, when executed individually or collectively by the at least one processor, cause the electronic device to at least
calculate a first position change between a first pixel of the reference crop image and a second pixel of a first crop image corresponding to the first pixel, and
calculate a first optical flow value of the first crop image based on the first position change.

19. The electronic device of claim 15, wherein the instructions, when executed individually or collectively by the at least one processor, cause the electronic device to at least
determine an error image among the plurality of crop images based on the plurality of optical flow values, and
determine the plurality of alignment images based on the error image.

20. The electronic device of claim 19, wherein the instructions, when executed individually or collectively by the at least one processor, cause the electronic device to at least
determine a first crop image and a second crop image adjacent to the first crop image among the plurality of crop images,
calculate a difference between a first optical flow value of the first crop image and a second optical flow value of the second crop image, and
determine whether the first crop image is the error image based on the difference.
